(19) United States
(12) Patent Application Publication
(10) Pub. No.: US 2015/0113416 A1
(43) Pub. Date: Apr. 23, 2015

(54) TRANSMISSION PATH MANAGEMENT DEVICE

(71) Applicant: POWER-ALL NETWORKS LIMITED, Shatin (HK)

(72) Inventors: KAI ZHOU, Wuhan (CN); HAI-TAO LI, Wuhan (CN); MAO-HUA HE, Wuhan (CN)

(21) Appl. No.: 14/511,782

(22) Filed: Oct. 10, 2014

(30) Foreign Application Priority Data
Oct. 18, 2013 (CN) 201310489954.9

(51) Int. Cl. H04L 12/24; G06F 3/0484

(52) U.S. Cl. CPC H04L 41/22; G06F 3/0484
USPC 715/736

(57) ABSTRACT

A transmission path management device includes a communication unit, a storage unit, and a processor. The communication unit is used to connect to a number of path control devices located in different areas. The processor is used to run a number of modules including an interface providing module to provide a user interface provided for a user to input a start area and an end area of a virtual lease line (VLL) to be established; a request receiving module to receive a VLL establishing request; an assignment module to assign a VLL identifier code to the VLL to be established; and a sending module to send the VLL establishing request and the VLL identifier code to the path control device located in a start area, thus to trigger the path control device located in the start area and related path control devices to determine and establish the VLL.

### CROSS-REFERENCE TO RELATED APPLICATIONS

This application claims priority to Chinese Patent Application No. 201310489954.9 filed on Oct. 18, 2013, in the China Intellectual Property Office, the contents of which are incorporated by reference herein. This application is related to the following co-pending, commonly assigned patent applications, the disclosures of which are incorporated herein by reference in their entirety:

1. “NETWORK SYSTEM CAPABLE OF ENHANCING CONNECTION PERFORMANCE” by Zhou et al., whose Attorney Docket No is U.S. 53458.

2. “TRANSMISSION PATH CONTROL DEVICE” by Zhou et al., whose Attorney Docket No is U.S. 53454.

3. “TRANSMISSION PATH MANAGEMENT SYSTEM AND METHOD” by Zhou et al., whose Attorney Docket No is U.S. 53456.

4. “ TRANSMISSION PATH CONTROL SYSTEM” by Zhou et al., whose Attorney Docket No is U.S. 53443.

5. “TRANSMISSION PATH MANAGEMENT SYSTEM AND METHOD” by Zhou et al., whose Attorney Docket No is U.S. 53457.

6. “ON-DEMAND TRANSMISSION PATH PROVIDING SYSTEM AND METHOD” by Zhou et al., whose Attorney Docket No is U.S. 53455.

### FIELD

The present disclosure relates to management devices, and particularly to a transmission path management device.

### BACKGROUND

Nowadays, people located distant from each other can communicate via a transmission path randomly generated in a network. However, random generation of the transmission path in the network can be complex and may cause a long delay time.

### BRIEF DESCRIPTION OF THE DRAWINGS

Implementations of the present technology will now be described, by way of example only, with reference to the attached figures.

FIG. 1 is a diagrammatic view of a transmission path management device connected to a number of path control devices.

FIG. 2 is a block diagram of the transmission path management device of FIG. 1.

FIG. 3 is a diagrammatic view of a user interface provided by the transmission path management device.

FIG. 4 is a block diagram of a path control device connected to the transmission path management device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

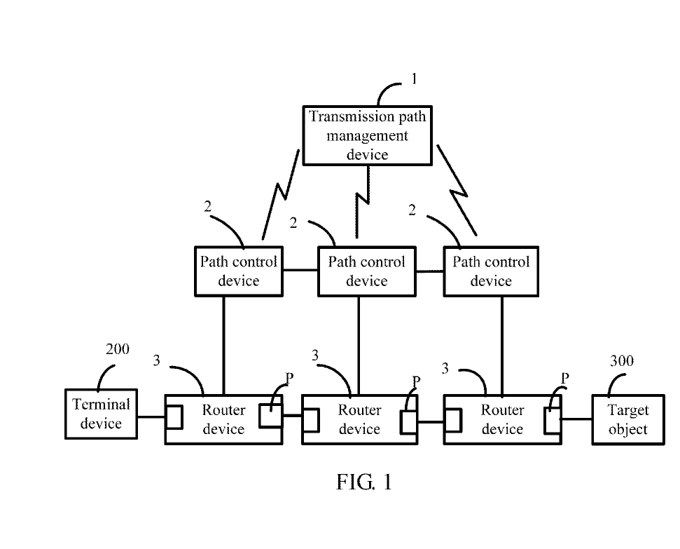

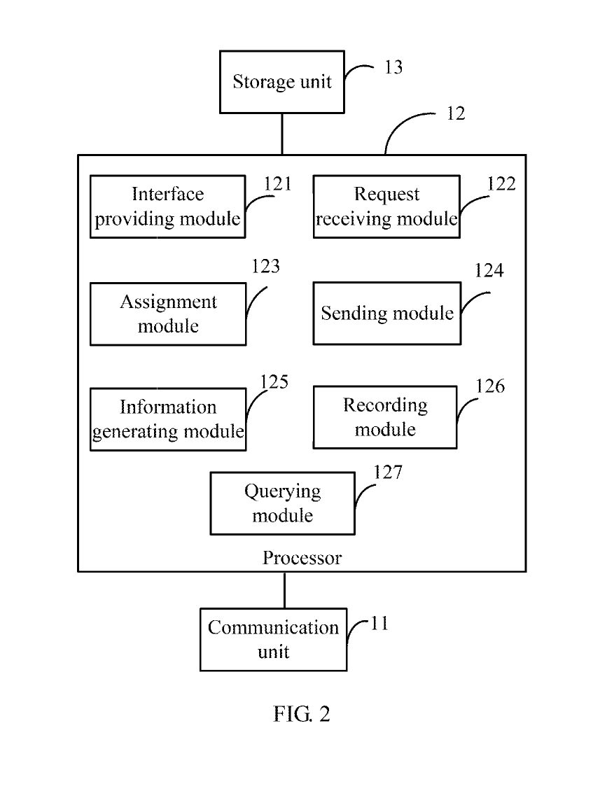

Referring to FIG. 1 and FIG. 2, a transmission path management device 1 is illustrated. The transmission path management device 1 is connected to a number of path control devices 2 located in different areas, specially, located in different geographic areas, via corresponding networks. Each two path control devices 201 are communicated to each other via corresponding networks. Each path control device 2 is also connected to a router device 3 located in the same area as the area where the path control device 2 locates. For example, one path control device 2 and the corresponding router device 3 are located in New York, another path control device 2 and the corresponding router device 3 are located in Philadelphia.

The network can be Internet, a wireless network including WIFI and BLUETOOTH, a telecommunication network including a general packet radio service (GPRS) network and a code division multiple access (CDMA) network, or a broadcasting network, for example. The network between the transmission path management device 1 and the path control device 2 and the network between the each two path control devices 2 can be the same or different.

The transmission path management device 1 can be a server or a server group. The path control device 2 can be a server or a personal computer. The router device 3 can be a router, a switch, or a gateway device, and includes a number of ports P.

The transmission path management device 1 is used to transmit a virtual lease line (VLL) establishing request including information of a start area and an end area of the VLL to one of the path control devices 2 when the transmission path management device 1 receives the VLL establishing request from a user. Corresponding path control devices 2 determine which router devices 3 are transmission nodes constituting the VLL according to the start area and the end area, and connect corresponding ports of the router devices 2 determined as the transmission nodes to establish the VLL.

In detail, referring to FIG. 2, the transmission path management device 1 includes a communication unit 11, a processor 12, and a storage unit 13.

The storage unit 13 stores relationships between a network address, an identification code, and an area of each path control device 2. The identification code can be a hardware identification number or a device identification code, for example. The network address can be a Internet protocol (IP) address.

The communication unit 11 is used to communicate to each path control device 2 via the corresponding network. The communication unit 11 can be a network card, a WIFI chip, a telephone card, or the like.

The processor 12 is used to run an interface providing module 121, a request receiving module 122, an assignment module 123, a sending module 124, an information generating module 125, a recording module 126, and a querying module 127.

In the embodiment, the interface providing module 121, the request receiving module 122, the assignment module 123, the sending module 124, the information generating module 125, the recording module 126, and the querying module 127 can be collections of software instructions stored in the storage unit 13 of the transmission path management device 1 and executed by the processor 12 of the transmission path management device 1. The interface providing module 121, the request receiving module 122, the assignment module 123, the sending module 124, the information generating module 125, the recording module 126, and the querying module 127 also can include functionality represented as hardware or integrated circuits, or as software and hardware combinations, such as a special-purpose processor or a general-purpose processor with special-purpose firmware.

In one embodiment, the processor 12 can be a central processing unit, a digital signal processor, or a single chip, for example. In one embodiment, the storage unit 13 can be an internal storage system, such as a flash memory, a random access memory (RAM) for temporary storage of information, and/or a read-only memory (ROM) for permanent storage of information. The storage unit 13 can also be a storage system, such as a hard disk, a storage card, or a data storage medium. The storage unit 13 can include volatile and/or non-volatile storage devices. In at least one embodiment, The storage unit 13 can include two or more storage devices such that one storage device is a memory and the other storage device is a hard drive. Additionally, one or more of the storage units 13 can be respectively located either entirely or partially external relative to the transmission path management device 1.

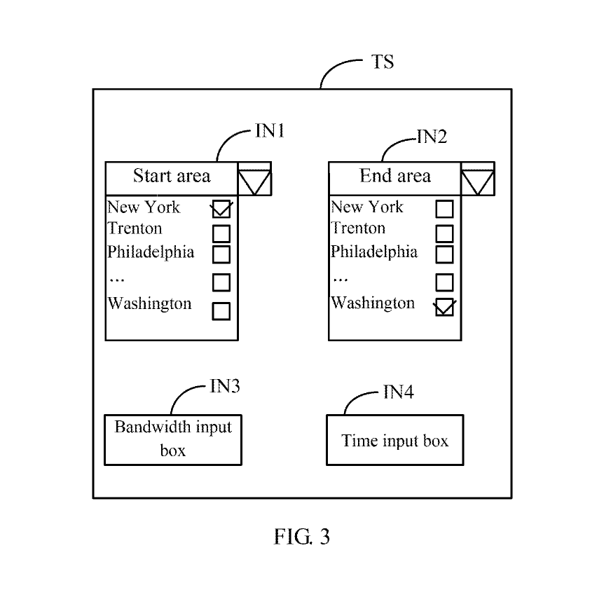

Referring also to FIG. 3, the interface providing module 11 is used to provide a user interface TS provided for the user to input the start area and the end area of the VLL. In detail, the user interface TS at least includes a start input box IN1 and an end input box IN2. The start input box IN1 is provided to input or select the start area of the VLL, and the end input box IN2 is provided to input or select the end area of the VLL. The interface providing module 11 can provide the user interface TS when the user logs in a corresponding login webpage successfully. As shown in FIG. 3, the start input box IN1 and the end input box IN2 are drop-down list boxes, and can provide a list including a number areas in response to user operations. In another embodiment, the start input box IN1 or the end input box IN2 also can be provided to input the start area or the end area directly.

The request receiving module 12 is used to receive a VLL establishing request provided by an operation on the user interface TS by the user. In detail, the operation on the user interface TS by the user can be that the user inputs or selects the start area and the end area respectively via the start input box IN1 and the end input box IN2. Therefore, when the user wants to establish the VLL, the user can input or select the start area and the end area of the VLL via the user interface TS to produce the VLL establishing request including the information for the start area and the end area of the VLL to be established.

The assignment module 123 is used to assign a VLL identifier code to the VLL to be established. In the embodiment, the assignment module 123 also associates the VLL identifier code with an identity of the user. The identity of the user can be a user name which the user used to log in the user interface TS, or an identity card number of the user.

The sending module 124 is used to send the VLL establishing request and the VLL identifier code to the path control device 2 located in the start area, thus to trigger the path control device 2 located in the start area and related path control devices 2 to determine the VLL and establish the VLL, specially, to determine the VLL and establish the VLL according to the information for the start area and the end area of the VLL. In the embodiment, the sending module 124 determines the network address of the path control device 2 located in the start area according to the relationship between the network address, the identification code, and the area of the path control device 2 located in the start area. The sending module 124 then transmits the VLL establishing request to the path control device 2 located in the start area via the network address of the path control device 2 located in the start area.

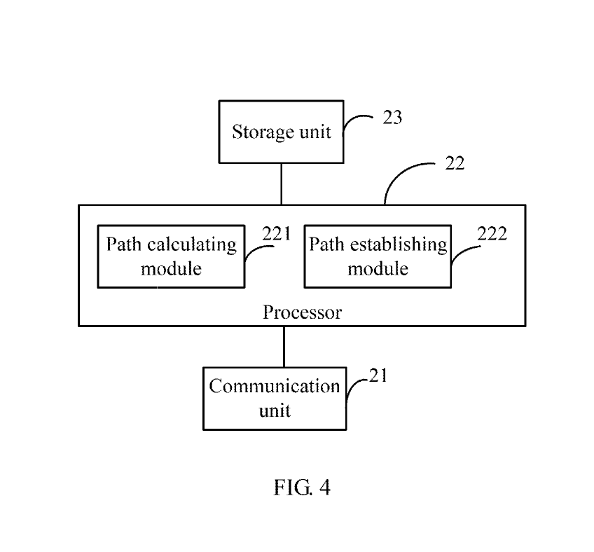

Referring to FIG. 4, each path control device 2 includes a communication unit 21, a processor 22, and a storage unit 23.

The communication unit 21 is used to communicate with the transmission path management device 1 via the corresponding network, and is used to communicate with the communication unit 21 of another the path control device 2. The communication unit 21 also can be a network card, a WIFI module, a telephone card, or the like.

The storage unit 23 stores a port topology file of the corresponding router device 3 connected to the path control device 2. The port topology file includes areas respectively directed by the ports P of the router device 3. In the embodiment, each area directed by one port P of the router device 3 is the area that another router device 3 connects to the router device 3 via the corresponding port P is located in.

The processor 22 is used to run a path calculating module 221 and a path establishing module 222.

In the embodiment, the path calculating module 221 and the path establishing module 222 can be collections of software instructions stored in the storage unit 23 of the path control device 2 and executed by the processor 22 of the path control device 2. The path calculating module 221 and the path establishing module 222 also can include functionality represented as hardware or integrated circuits, or as software and hardware combinations, such as a special-purpose processor or a general-purpose processor with special-purpose firmware.

In one embodiment, the processor 22 can be a central processing unit, a digital signal processor, or a single chip, for example. In one embodiment, the storage unit 23 can be an internal storage system, such as a flash memory, a random access memory (RAM) for temporary storage of information, and/or a read-only memory (ROM) for permanent storage of information. The storage unit 23 can also be a storage system, such as a hard disk, a storage card, or a data storage medium. The storage unit 23 can include volatile and/or non-volatile storage devices. In at least one embodiment, The storage unit 23 can include two or more storage devices such that one storage device is a memory and the other storage device is a hard drive. Additionally, one or more of the storage units 23 can be respectively located either entirely or partially external relative to the path control device 2.

The path calculating module 221 is used to determine whether there is one port P of the corresponding router device 3 connected to the path control device 2 is directed to an end area according to the port topology file of the router device 3 when the path control device 2 receives the VLL establishing request. If not, namely if there is no port P of the router device 3 is directed to the end area, the path calculating module 221 transmits the VLL establishing request to a default path control device 2 which is also defined in the topology file. Namely, the topology file also defines which path control device 2 is the default path control device 2 of each path control device 2. The path calculating module 221 of the default path control device 2 executes the function as described above. Namely, the path calculating module 221 of the default path control device 2 determines whether there is one port P of a default router device 3 connected to the default path control device 2 is directed to the end area. If not, the path calculating module 221 of the default path control device 2 transmits the VLL establishing request to another default path control device 2. Therefore, the path calculating module 221 executes the above steps repeatedly, until the path calculating module 221 determines one port P of one router device 3 connected to the current path control device 2 is directed to the end area. In the embodiment, the default path control device 2 and the path control device 2 located in the end area are regarded as the related path control devices 2 described above.

The path calculating module 221 further determines which router devices 3 are transmission nodes constituting the VLL and determines which ports P are ports to be connected to another port of the router devices 3 determined as the transmission nodes constituting the VLL and generates VLL establishing information including connection relationships of the router device 3 determined as the transmission nodes of the VLL and the ports P to be connected. In the embodiment, the path calculating module 221 determines the router devices 3 connected to the path control devices 221 receiving the VLL establishing request as the transmission nodes constituting the VLL. The path calculating module 221 determines the ports P directed to the area the default router device 3 locates in and the port P directed to the end area as the ports P to be connected.

In the embodiment, the path calculating modules 221 of the path control devices 2 are communicated to each other and share the VLL establishing information. In another embodiment, the path calculating module 221 of each path control device 2 receiving the VLL establishing request sends a determination result of determining whether one port P of the corresponding router device 3 is directed to the end area to the path calculating module 221 of the path control device 2 located in the start area. The path calculating module 221 of the path control device 2 located in the start area obtains the VLL generates the VLL establishing information based on the determination result sent by the other path control devices 2.

The path establishing module 222 is used to label the ports P to be connected the router devices 3 determined as the transmission nodes constituting the VLL by using the VLL identifier code, and connect the ports P labeled with the VLL identifier code one by one, thus to establish the VLL. In detail, the path establishing module 222 connects the adjacent ports P labeled with the VLL identifier code one by one to establish the VLL. The related technology of establishing the VLL are disclosed in a related patent applications whose attorney docket No. are U.S. 53456 and U.S. 53457.

The information generating module 125 is used to provide a connection information to the user according to the VLL establishing request sent from the terminal device 200 of the user. In the embodiment, the connection information includes the network address of the path control device 3 located in the start area and login information. The login information includes a user name and a password used to connect to the path control device 3 located in the start area. Therefore, the user can access a connection interface provided by the path control device 3 according to the network address of the path control device 3 and then input the user name and the password to the connection interface provided by the path control device 2 to connect the terminal device 200 with the path control device 2.

The path establishing module 221 further connects the terminal device 200 with the corresponding router device 3 located in the start area upon the terminal device 200 is connected to the path control device 2 located in the start area.

In the embodiment, the path establishing module 222 of the path control device 2 located in the end area further connects the router device 3 located in the end area to a target object 300, thus to establish the connection between the router device 3 located in the end area and the target object 300. The target object 300 can be another terminal device 200 or a network, such as a private network, Internet, for example.

Therefore, the user can access to/communicate with the target object 300 via the established VLL.

In the embodiment, the user interface TS also provides a bandwidth input box IN3 and a time input box IN4. The bandwidth input box IN3 is provided to input the bandwidth of the requested VLL, and the time input box IN4 is provided to input a start time and an end time of the requested VLL. The VLL establishing request received by the request receiving module 122 further includes information of the bandwidth and the start time, the end time input by the user. The path control device 2 and the related path control device 3 are trigged to establish the VLL with the corresponding bandwidth during the start time and the end time upon receiving the VLL establishing request.

In detail, the path establishing module 222 of each path control device 2 connected to the router device 3 determined as the transmission node of the VLL controls to configure the ports P labeled with the VLL identifier code of the corresponding router device 3 to enable the ports P labeled with the VLL identifier code only can transmit data during the start time and the end time with the corresponding bandwidth.

The recording module 126 is used to receive a register request from a path control device 2, and store the network address of the path control device 2, the identification code, and the area of the path control device 2 to the storage unit 13 when receiving the register request from the path control device 2. In the embodiment, the transmission path management device 1 and the registered path control devices 2 constitute a transmission path control system.

The querying module 127 is used to provide state information of the VLL when receiving a query request input by a user via the user interface TS provided by the interface providing module 121. The state information includes the bandwidth of the VLL, the start time and the end time of the VLL, or information whether the VLL is established successfully.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission path management device comprising:
a communication unit configured to connect to a plurality of path control devices located in different areas;
a storage unit configured to store a plurality of modules which are collections of instructions; and
at least one processer configured to execute the plurality of modules, the plurality of modules comprising:
an interface providing module configured to provide a user interface for a user to input a start area and an end area of a virtual lease line (VLL) to be established;
a request receiving module configured to receive a VLL establishing request provided by an operation on the user interface by the user, the VLL establishing request comprising information for the start area and the end area of the VLL to be established;
an assignment module configured to assign a VLL identifier code to the VLL to be established; and
a sending module configured to send the VLL establishing request and the VLL identifier code to a path control device located in the start area, thus to trigger the path control device located in the start area and related path control devices to determine the VLL and establish the VLL.

2. The device according to claim 1, wherein the storage unit further stores relationships between a network address, an identification code, and an area of each path control device; the sending module determines the network address of the path control device located in the start area according to the relationship between the network address, the identification code, and the area of the path control device located in the start area, and transmits the VLL establishing request to the path control device located in the start area via the network address of the path control device located in the start area.

3. The device according to claim 1, wherein the storage unit further stores relationships between a network address, an identification code, and an area of each path control device; the modules further comprise an information generating module configured to provide connection information to the user according to the VLL establishing request, the connection information comprises the network address of the path control device located in the start area and login information provided to connect a terminal device of the user with the path control device located in the start area.

4. The device according to claim 1, wherein the user interface further provides a bandwidth input box provided to input the bandwidth of the requested VLL and a time input box provided to input a start time and an end time of the requested VLL, the VLL establishing request received by the request receiving module further comprises information of the bandwidth and the start time, the end time input by the user, the sending module sends the VLL establishing request and the VLL identifier code to the path control device located in the start area to trigger the path control device and the related path control device to establish the VLL with the corresponding bandwidth during the start time and the end time.

5. The device according to claim 1, wherein the modules further comprise a recording module configured to receive a register request from a path control device, and store a network address of the path control device, an identification code, and an area of the path control device to the storage unit when receiving the register request from the path control device.

6. The device according to claim 1, wherein the modules further comprise a querying module configured to provide state information of the VLL when receiving a query request input by a user via the user interface provided by the interface providing module. The state information includes the bandwidth of the VLL.

7. The device according to claim 6, wherein the state information of the VLL comprises the bandwidth, the start time and the end time of the VLL, and information about whether the VLL is established successfully.

8. The device according to claim 1, wherein the transmission path management device is a single server or a server group.
